(19) United States
(12) Patent Application Publication
(10) Pub. No.: US 2023/0400805 A1
(43) Pub. Date: Dec. 14, 2023

(54) IMAGE FORMING APPARATUS CAPABLE OF ACCURATELY CALCULATING OPC DRUM WEAR AMOUNT

(71) Applicant: KYOCERA Document Solutions Inc., Osaka (JP)

(72) Inventors: Kiyotaka Kobayashi, Osaka (JP); Masataka Okada, Osaka (JP)

(21) Appl. No.: 18/331,870

(22) Filed: Jun. 8, 2023

(30) Foreign Application Priority Data
Jun. 9, 2022 (JP) 2022-093778

(51) Int. Cl. G03G 15/00; G03G 15/01

(52) U.S. Cl. CPC G03G 15/5033; G03G 15/0105

(57) ABSTRACT

An image forming apparatus includes a monochrome OPC drum, a color OPC drum, a charger, a developer, and a calculating portion. The charger charges a surface of a photosensitive layer of the color OPC drum. The developer performs development using a developing agent including a toner and a carrier. The calculating portion calculates a wear amount of the photosensitive layer of the color OPC drum. In addition, the charger charges the photosensitive layer of the color OPC drum during monochrome printing to a surface potential that suppresses toner adhesion and carrier adhesion to the color OPC drum. Further, the calculating portion calculates the wear amount of the photosensitive layer of the color OPC drum during monochrome printing to be less than during color printing.

### INCORPORATION BY REFERENCE

This application is based upon and claims the benefit of priority from the corresponding Japanese Patent Application No. 2022-093778 filed on Jun. 9, 2022, the entire contents of which are incorporated herein by reference.

### BACKGROUND

The present disclosure relates to an image forming apparatus.

In an electrophotographic image forming apparatus, as a method for uniformly charging a surface of a photoconductor drum, a corona discharge method using a corona discharger and a contact charging method using a conductive charging member typified by a charging roller are known. In the corona discharge method, many corona products such as ozone are generated, and components in air are decomposed by ozone to produce ion products such as NOx and SOx. Therefore, in recent years, in order to improve office environment, a contact charging method capable of suppressing generation of ozone, NOx, SOx, or the like has been adopted instead of the corona discharge method.

In the contact charging method, the photoconductor drum is charged by discharging near the surface of the photoconductor drum, and the discharge accelerates wear of a photosensitive layer of the photoconductor drum. Particularly, in a case where a single-layer organic photoconductor (OPC) drum is used as the photoconductor drum, as the photosensitive layer wears, capacitance thereof increases and changes an amount of charge that must be applied to a surface of the OPC drum to form an optimal electrostatic latent image. In addition, a discharge start voltage changes due to wear of the photosensitive layer, and thus in order to form a stable image over a long period of time while maintaining a constant surface potential, it is necessary to apply a charging voltage corresponding to a film thickness of the photosensitive layer.

The speed at which the wear of the OPC drum progresses varies depending on the state of application of a charging voltage to a charging member, that is, the state of application of a charging bias between the OPC drum and the charging member. Therefore, when the wear amount of the OPC drum is calculated simply by proportional calculation using a cumulative number of rotations of the OPC drum, the accuracy of calculation of the wear amount may worsen depending on a driving state and surface potential (applied voltage) of the OPC drum. As a method of calculating the wear amount, a method of calculating the wear amount of the photosensitive layer based on a charging current flowing between the photosensitive layer of the photoconductor drum and the charging roller is known.

### SUMMARY

An image forming apparatus according to a first aspect of the present disclosure is an image forming apparatus with a monochrome OPC drum and a color OPC drum, including a charger, a developer, and a calculating portion. The charger charges a surface of a photosensitive layer of the color OPC drum. The developer performs development using a developing agent including a toner and a carrier. The calculating portion calculates a wear amount of the photosensitive layer of the color OPC drum. In addition, the charger charges the photosensitive layer of the color OPC drum during monochrome printing to a surface potential that suppresses toner adhesion and carrier adhesion to the color OPC drum. Further, the calculating portion calculates the wear amount of the photosensitive layer of the color OPC drum during monochrome printing to be less than during color printing.

An image forming apparatus according to a second aspect of the present disclosure is an image forming apparatus with a monochrome OPC drum and a color OPC drum, including a charger, a developer, and a calculating portion. The charger charges a surface of a photosensitive layer of the color OPC drum. The developer performs development using a developing agent including a toner and a carrier. The calculating portion calculates a wear amount of the photosensitive layer of the color OPC drum. In addition, the charger charges the photosensitive layer of the color OPC drum during monochrome printing to a surface potential that is lower than a surface potential during color printing, and that suppresses a change in the wear amount of the photosensitive layer of the color OPC drum during monochrome printing and during color printing.

An image forming apparatus according to a third aspect of the present disclosure is an image forming apparatus with a monochrome OPC drum and a color OPC drum, including a charger, a developer, and a calculating portion. The charger charges a surface of a photosensitive layer of the color OPC drum. The developer performs development using a developing agent including a toner and a carrier. The calculating portion calculates a wear amount of the photosensitive layer of the color OPC drum. In addition, the charger charges the photosensitive layer of the color OPC drum during monochrome printing so that a surface potential of the photosensitive layer of the color OPC drum decreases as a film thickness of the photosensitive layer of the color OPC drum decreases.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram of a printer of a first embodiment.

FIG. 2 is an enlarged schematic diagram of an image forming unit of the first embodiment.

FIG. 3 is a diagram showing the relationship between surface potential of a photosensitive layer and voltage applied by a charger.

### DETAILED DESCRIPTION

### First Embodiment

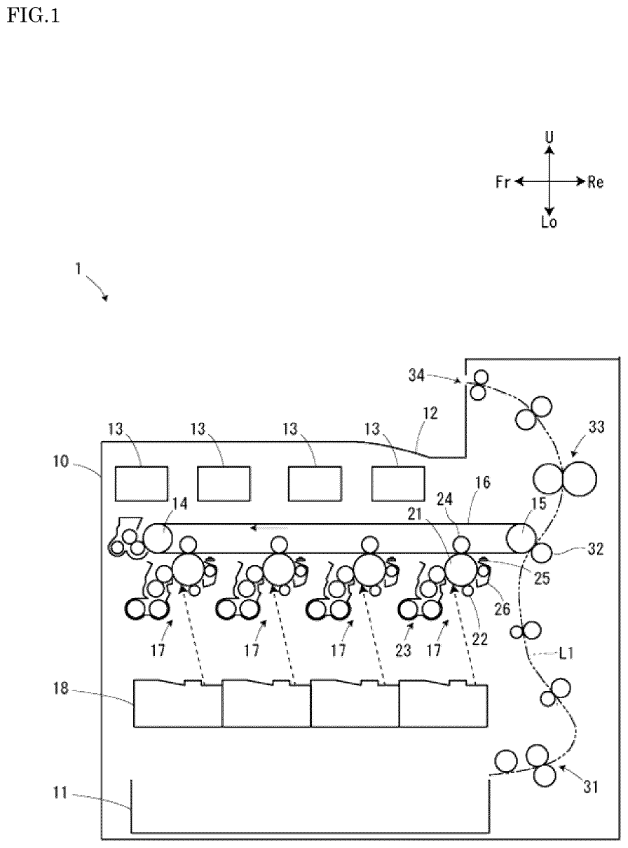

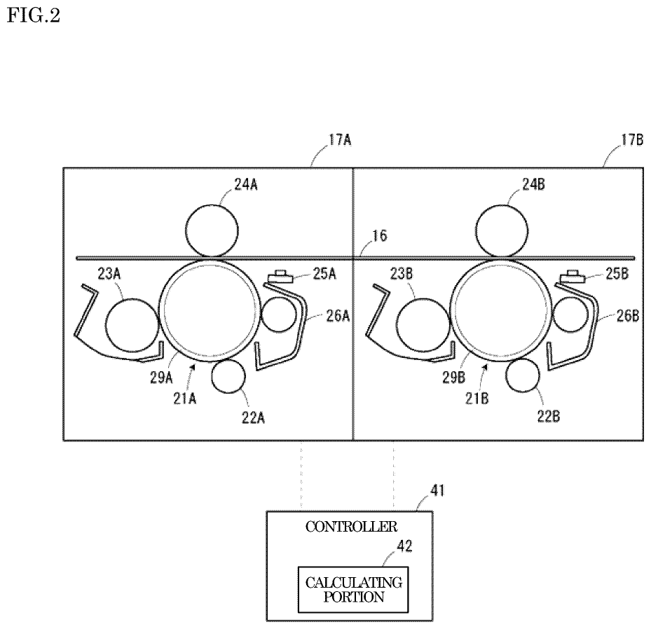

A first embodiment will be described below with reference to the drawings. Note that in the following description, a printer will be exemplified as an image forming apparatus. FIG. 1 is a schematic diagram of a printer of a first embodiment. FIG. 2 is an enlarged schematic diagram of an image forming unit of the first embodiment. Note that arrows Fr, Re, U, and Lo appropriately provided to each figure indicate the front side, rear side, upper side, and lower side of the printer, respectively. In addition, in the following description, A and B are used when distinguishing image forming units, and A and B are omitted when not distinguishing image forming units.

As shown in FIG. 1, the printer 1 includes a box-shaped housing 10 in which various types of devices are housed. A sheet feed cassette 11 in which a bundle of sheets are set is accommodated in a lower part of the housing 10, and a sheet discharge tray 12 on which sheets on which images have been formed are stacked is provided in an upper part of the housing 10. Below the sheet discharge tray 12, toner containers 13 containing toner are detachably set for each toner color (for example, four colors of magenta, cyan, yellow, and black). An intermediate transfer belt 16 stretched over a pair of rollers 14 and 15 is provided below the plurality of toner containers 13.

Below the intermediate transfer belt 16, image forming units 17 for monochrome or color are arranged in a conveying direction of the intermediate transfer belt 16. Each image forming unit 17 is rotatably provided with a single-layer OPC (Organic Photo Conductor) drum 21 in rolling contact with the intermediate transfer belt 16. Around each OPC drum 21, a charger 22, a developer 23, a primary transfer roller 24, a charge removal portion 25, and a cleaning device 26 are installed in order of a primary transfer process. A carrier is accommodated in a stirring chamber of each developer 23, and toner and carrier supplied from each toner container 13 are stirred to produce a two-component developing agent.

An exposure device 18 configured by a laser scanning unit (LSU) is provided below each image forming unit 17. A sheet conveying path L1 from the sheet feed cassette 11 to the sheet discharge tray 12 is formed at a side portion of the housing 10 by a plurality of rollers. A sheet feed portion 31 is provided at an upstream side (lower side) of the conveying path L1, and a secondary transfer roller 32 is provided in the conveying path L1 at an end on a side of the intermediate transfer belt 16 downstream of the sheet feed portion 31. A fixing device 33 is provided at a downstream side of the secondary transfer roller 32 in the conveying path L1, and a sheet outlet 34 is provided at a downstream end side (upper side) of the conveying path L1.

During image formation by the printer 1, after the surface of the OPC drum 21 is charged by the charger 22, an electrostatic latent image is formed on the surface of the OPC drum 21 by a laser beam from the exposure device 18. Next, toner is adhered from the developer 23 to the electrostatic latent image on the surface of the OPC drum 21 to form a toner image, and the toner image is primarily transferred from the surface of the OPC drum 21 to the surface of the intermediate transfer belt 16. In each image forming unit 17, by primarily transferring a toner image of each color onto the intermediate transfer belt 16, a full-color toner image is formed on the surface of the intermediate transfer belt 16. Any electric charge and waste toner remaining on the OPC drum 21 are removed by the charge removal portion 25 and the cleaning device 26.

On the other hand, the sheet feed portion 31 takes a sheet from the sheet feed cassette 11 or from a manual feed tray (not shown), and conveys the sheet toward the secondary transfer roller 32 in synchronization with the timing of the image forming operation described above. A full-color toner image is secondarily transferred from the surface of the intermediate transfer belt 16 to the surface of the sheet by the secondary transfer roller 32, and the transferred sheet is conveyed toward the fixing device 33 downstream of the secondary transfer roller 32. The toner image is fixed on the sheet by the fixing device 33, and the sheet on which the toner image is fixed is discharged from a sheet discharge outlet 34 onto the sheet discharge tray 12. As described above, the toner image transferred to the sheet passes through the fixing device 33 to form an image on the surface of the sheet.

As illustrated in FIG. 2, the printer 1 is compatible with color printing and monochrome printing, and has an image forming unit 17A for color and an image forming unit 17B for monochrome. A surface of an OPC drum (color OPC drum) 21A of the image forming unit 17A is formed by a single-layer photosensitive layer 29A, and similarly, a surface of an OPC drum (monochrome OPC drum) 21B of the image forming unit 17B is formed by a single-layer photosensitive layer 29B. Image forming processing is performed using the image forming units 17A and 17B during color printing, and image forming processing is performed using the image forming unit 17B during monochrome printing.

In the printer 1, even during monochrome printing, the color OPC drum 21A and the intermediate transfer belt 16 are in contact with each other. In this configuration, when the OPC drum 21A is not electrically charged during monochrome printing, the performance of the OPC drum 21A deteriorates, and surface potential of the OPC drum 21A cannot be appropriately controlled in the next color printing. Therefore, it is necessary to electrically charge the OPC drum 21A during monochrome printing; however, depending on the surface potential of the OPC drum 21A, toner and carrier are consumed, and the photosensitive layer 29A may become excessively worn. More specifically, a developer 23A performs development using a developing agent including toner and carrier, and when the surface potential of the photosensitive layer 29A during monochrome printing is too low, the positively charged toner will be attracted, and when the surface potential of is too high, negatively charged carrier will be attracted. Therefore, it is desirable to control the surface potential of the OPC drum 21.

In order to keep the surface potential of the OPC drum 21A constant during color printing, it is necessary to apply a charging voltage corresponding to a film thickness of the photosensitive layer 29A. Here, in a case where the surface of the OPC drum 21A is formed of a single-layered photosensitive layer 29A without an overcoat, the photosensitive layer 29A wears due to discharge during charging of the OPC drum 21A, and the film thickness changes. Normally, the wear amount of the photosensitive layer 29A is obtained by multiplying the number of rotations of the OPC drum 21A by the wear rate. However, the speed of progression of wear of the photosensitive layer 29A differs depending on the application state of the charging voltage, that is, the application state of the charging bias between the OPC drum 21A and the charger 22. Therefore, with this calculation method it is not possible to accurately calculate the wear amount of the photosensitive layer 29A in a case where the surface potential of the photosensitive layer 29A of the OPC drum 21A changes during color printing and monochrome printing.

On the other hand, a method of calculating the wear amount of the photosensitive layer 29A based on the charging current flowing between the photosensitive layer 29A of the OPC drum 21A and the charger 22 is known.

However, with the above-described method, a dedicated sensor such as a current sensor for detecting charging current must be added to the printer 1.

On the other hand, in the embodiment according to the present disclosure, as described below, it is possible to accurately calculate the wear amount of the OPC drum with a simple and inexpensive configuration.

More specifically, in the printer 1, the wear amount of the photosensitive layer 29A of the OPC drum 21A is calculated in consideration of the difference in surface potential of the photosensitive layer 29A during color printing and monochrome printing. A controller 41 is connected to the image forming units 17A, 17B, and the controller 41 is provided with a calculating portion 42. The controller 41 performs overall control of each part of the apparatus, and controls, for example, the power supply circuits of the charger 22A and the developer 23A, the drive motors of the rollers, and the like. The calculating portion 42 calculates the wear amount of the photosensitive layer 29A of the OPC drum 21A from the following Equation (1).

Wear amount=Number of revolutions of OPC drum×Scraping rate×Correction coefficient Equation (1)

Note that the controller 41 may be achieved by software using a processor, or may be achieved by a logic circuit (hardware) formed in an integrated circuit or the like. In a case of using a processor, various processes are performed by the processor reading and executing programs stored in a memory. As a processor, for example, a central processing unit (CPU) is used. The memory is configured by one or more storage devices such as read only memory (ROM), random access memory (RAM), or the like, depending on the application.

Here, a calculation process by the calculating portion 42 will be described. During monochrome printing, the charger 22A charges the photosensitive layer 29A of the OPC drum 21A to a surface potential that suppresses adhesion of toner and carrier to the OPC drum 21A. That is, the surface potential of the photosensitive layer 29A during monochrome printing is higher than a potential at which toner adhesion subsides and lower than a potential at which carrier adhesion occurs. More specifically, the surface potential of the photosensitive layer 29A during color printing is set within a range from 500 [V] to 700 [V]; however, the surface potential of the photosensitive layer 29A during monochrome printing is set within a range from 10[V] to 150[V].

The surface potential of the photosensitive layer 29A of the OPC drum 21A is lower during monochrome printing than during color printing, and thus the actual wear amount of the photosensitive layer 29A during monochrome printing is less than during color printing. Therefore, the calculating portion 42 calculates the wear amount of the photosensitive layer 29A of the OPC drum 21A during monochrome printing to be less than during color printing. More specifically, during color printing, the correction coefficient of Equation (1) is set to a value of 1.0; however, during monochrome printing, the correction coefficient of Equation (1) is set within the range of 0.5 to 0.8. Considering the difference in the surface potential of the photosensitive layer 29A during color printing and during monochrome printing, the calculating portion 42 calculates the wear amount of the photosensitive layer 29A with high accuracy.

The film thickness of the photosensitive layer 29A is obtained from the wear amount of the photosensitive layer 29A of the OPC drum 21A during color printing and monochrome printing. Therefore, by applying a charging voltage corresponding to the film thickness of the photosensitive layer 29A during color printing, it is possible to form an image while maintaining the surface potential of the photosensitive layer 29A at a desired level, thereby suppressing color fogging and improving the image quality. In particular, the calculation process by the calculating portion 42 described above is effective for achieving an OPC drum 21 having a long life (for example, capable of printing 150,000 sheets of A4 size vertically) in which the film thickness of the photosensitive layer 29 changes by 10 [μm] or more and the applied voltage changes by 100 [V] or more.

As described above, with the first embodiment, the photosensitive layer 29A of the color OPC drum 21A is charged during monochrome printing, and deterioration of the performance of the photosensitive layer 29A due to deterioration of electrical characteristics is suppressed. In addition, consumption of a developing agent such as toner and carrier may be suppressed by the surface potential of the photosensitive layer 29A. The surface potential of the photosensitive layer 29A during monochrome printing is lower than that during color printing, and thus excessive wear of the photosensitive layer 29A due to discharge is suppressed. The wear amount of the photosensitive layer 29A can be calculated with high accuracy in consideration of the difference in surface potential during color printing and during monochrome printing, and there is no need to add a dedicated sensor, contact or separation function, or the like to the printer 1. By applying a voltage corresponding to the film thickness of the photosensitive layer 29A, color fogging during color printing can be suppressed and image quality can be improved.

### Second Embodiment

Next, a second embodiment will be described. Note that the printer of the second embodiment differs from the printer of the first embodiment in that the wear amount of the photosensitive layer does not change between color printing and monochrome printing. Therefore, with regard to the second embodiment, descriptions of configurations that are the same as those of the first embodiment will be omitted. In addition, in the second embodiment, the same reference numerals are assigned to the same configurations as in the first embodiment.

Also in the second embodiment, the charger 22A charges the photosensitive layer 29A of the OPC drum 21A during monochrome printing. The photosensitive layer 29A during monochrome printing is charged to a surface potential that is lower than the surface potential of the photosensitive layer 29A during color printing, and is charged to a surface potential that suppresses a change in the wear amount of the photosensitive layer 29A during monochrome printing and during color printing. By suppressing the change in the wear amount of the photosensitive layer 29A, correction of the scraping rate in Equation (1) becomes unnecessary. More specifically, the surface potential of the photosensitive layer 29A during color printing is set within a range from 500 [V] to 700 [V]; however, the surface potential of the photosensitive layer 29A during monochrome printing is set within a range from 300[V] to 400[V].

The surface potential of the photosensitive layer 29A during monochrome printing is set to about 300 [V], and thus a development voltage Vdc is applied to the developing device 23A so that carrier does not adhere to the photosensitive layer 29A. A magnetic force of the developing roller is stronger than a force due to a potential difference between the photosensitive layer 29A and the developing device 23A, and thus the attraction of carriers to the photosensitive layer 29A is suppressed. In addition, the developing device 23A is stopped in order to suppress deterioration of color toner during monochrome printing, and by applying voltage while the developing device 23A is stopped, abnormality in the developing roller may occur. Therefore, the surface potential of the photosensitive layer 29A is set lower during monochrome printing than during color printing.

The change in the wear amount of the photosensitive layer 29A of the OPC drum 21A is small during color printing and monochrome printing, and thus the calculating portion 42 calculates the wear amount of the photosensitive layer 29A during monochrome printing in the same manner as the wear amount of the photosensitive layer 29A during color printing. More specifically, a value of 1.0 is set for the correction coefficient in Equation (1) during both color printing and monochrome printing. The film thickness of the photosensitive layer 29A is obtained from the wear amount of the photosensitive layer 29A of the OPC drum 21A during color printing and monochrome printing. Therefore, by applying a charging voltage corresponding to the film thickness of the photosensitive layer 29A during color printing, it is possible to form an image while maintaining the photosensitive layer 29A at a target surface potential, thereby improving the image quality.

As described above, according to the second embodiment, the photosensitive layer 29A of the color OPC drum 21A is charged during monochrome printing, and deterioration of performance of the photosensitive layer 29A due to deterioration of electrical characteristics is suppressed. In addition, by applying the development voltage Vdc to the developer 23A to adjust the potential difference between the photosensitive layer 29A and the developer 23A, consumption of developing agent such as toner and carrier can be suppressed. The surface potential of the photosensitive layer 29A is charged to a lower level during monochrome printing than during color printing, and deterioration of the developer 23A can be suppressed. The change in the wear amount of the photosensitive layer 29A is suppressed during monochrome printing and during color printing, and thus the wear amount of the photosensitive layer 29A is calculated using a simple calculation method, and there is no need to add a dedicated sensor, contact or separation function, or the like to the printer 1. By applying a voltage corresponding to the film thickness of the photosensitive layer 29A, color fogging during color printing can be suppressed and image quality can be improved.

### Third Embodiment

Next, a third embodiment will be described. Note that the printer of the third embodiment differs from the printer of the first embodiment in that the surface potential of the photosensitive layer is changed according to the film thickness of the photosensitive layer of the OPC drum. Therefore, with regard to the third embodiment, descriptions of configurations that are the same as those of the first embodiment will be omitted. In addition, in the third embodiment, the same reference numerals are given to configurations that are the same as in the first embodiment.

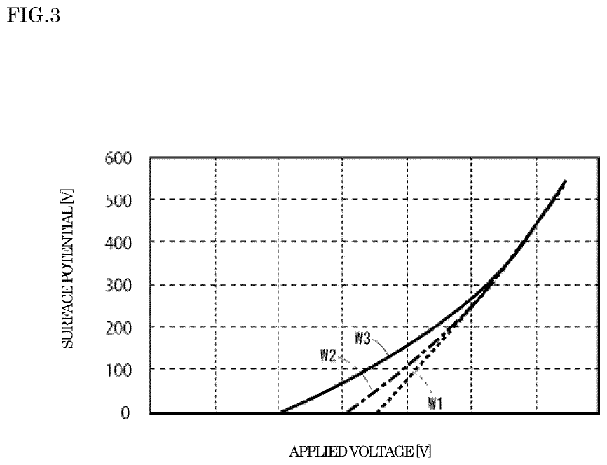

As illustrated in FIG. 3, the relationship between the surface potential of the photosensitive layer and the voltage applied by the charger 22 changes for each film thickness of the photosensitive layer of the OPC drum. In the thin film drum indicated by the dashed line W1, the surface potential and the applied voltage change substantially linearly as a whole, and the photosensitive layer 29 can be set to a target surface potential by the applied voltage. On the other hand, in the thick-film drum indicated by the dashed-dotted line W2 and the solid line W3, when the surface potential becomes equal to or less than a specified potential, the surface potential and the applied voltage do not change linearly, and it becomes difficult to set the photosensitive layer 29 to the specified surface potential or less by the applied voltage. Therefore, it is desirable to change the surface potential according to the film thickness of the photosensitive layer 29.

In the third embodiment as well, the charger 22A charges the photosensitive layer 29A of the OPC drum 21A during monochrome printing. The photosensitive layer 29A during monochrome printing is charged so that the surface potential of the photosensitive layer 29A decreases as the film thickness of the photosensitive layer 29A becomes thinner. More specifically, when the film thickness of the photosensitive layer 29A is 33 [μm] or more, the surface potential of the photosensitive layer 29A is set within a range from 500 [V] to 700 [V]. When the film thickness of the photosensitive layer 29A is 30 [μm] or more and less than 33 [μm], the surface potential of the photosensitive layer 29A is set within a range from 300 [V] to 400 [V]. When the film thickness of the photosensitive layer 29A is less than 30 [μm], the surface potential of the photosensitive layer 29A is set within a range from 10 [V] to 150 [V].

For example, in a case where the film thickness of the photosensitive layer 29A is 33 [μm], when the surface potential is 500 [V] or more, the surface potential and the applied voltage change substantially linearly, and the photosensitive layer 29A can be charged to the target surface potential by the applied voltage. Therefore, the photosensitive layer 29A is charged to the same surface potential during both color printing and monochrome printing. The surface potential of the photosensitive layer 29A during monochrome printing is set to about 500 [V], and thus the development voltage Vdc is applied to the developer 23A so that carrier does not adhere to the photosensitive layer 29A. Note that the carrier may be collected by rotating the developer 23A for color in the reverse direction during monochrome printing.

In a case where the film thickness of the photosensitive layer 29A is 30 [μm] or more and less than 33 [μm], when the surface potential is 300 [V] or more, the surface potential and the applied voltage change substantially linearly, and the photosensitive layer 29A can be charged to the target surface potential by the applied voltage. In this case, the surface potential of the photosensitive layer 29A during monochrome printing is set to about 300 [V] as in the second embodiment, and thus a developing voltage Vdc is applied to the developer 23A so that the carrier does not adhere to the photosensitive layer 29A. In addition, by setting the surface potential of the photosensitive layer 29A lower during monochrome printing than during color printing, abnormalities of the developing roller are suppressed.

In a case where the film thickness of the photosensitive layer 29A is less than 30 [μm], the surface potential and the applied voltage change substantially linearly as a whole, and the photosensitive layer 29A can be charged to a target surface potential by the applied voltage. In this case, the surface potential of the photosensitive layer 29A during monochrome printing is set within a range from 10 [V] to 150 [V] as in the first embodiment, and thus adhesion of toner and carrier to the photosensitive layer 29A is suppressed. The surface potential of the photosensitive layer 29A is set low, and thus the wear amount of the photosensitive layer 29A during monochrome printing is reduced. In this way, the surface potential of the photosensitive layer 29A is changed stepwise according to the film thickness.

In a case where the film thickness of the photosensitive layer 29A is 33 [μm] or more, the surface potential of the photosensitive layer 29A during monochrome printing is charged to the same surface potential as the photosensitive layer 29A during color printing. In a case where the film thickness of the photosensitive layer 29A is 30 [μm] or more and less than 33 [μm], the surface potential of the photosensitive layer 29A during monochrome printing is charged to a surface potential lower than the surface potential of the photosensitive layer 29A during color printing; however, the wear amount of the photosensitive layer 29A changes little during monochrome printing and during color printing. Therefore, the calculating portion 42 calculates the wear amount of the photosensitive layer 29A during monochrome printing in the same manner as the wear amount of the photosensitive layer 29A during color printing. More specifically, a value of 1.0 is set for the correction coefficient in Equation (1) during both color printing and monochrome printing.

On the other hand, in a case where the film thickness of the photosensitive layer 29A is less than 30 [μm], the actual wear amount of the photosensitive layer 29A during monochrome printing is smaller than during color printing. Therefore, the calculating portion 42 calculates the wear amount of the photosensitive layer 29A of the OPC drum 21A during monochrome printing to be less than during color printing. More specifically, during color printing, the correction coefficient of Equation (1) is set to a value of 1.0; however, during monochrome printing, the correction coefficient of Equation (1) is set within the range of 0.5 to 0.8. The film thickness of the photosensitive layer 29A is obtained from the wear amount of the photosensitive layer 29A of the OPC drum 21A during color printing and monochrome printing.

In this way, in a case where the photosensitive layer 29A has a first film thickness (33 [μm] or more), the charger 22A charges the photosensitive layer 29A during monochrome printing to the same first surface potential (potential within a range from 500 [V] to 700 [V]) in the same way as during color printing. In a case where the photosensitive layer 29A has a second film thickness (30 [μm] or more and less than 33 [μm]) thinner than the first film thickness, the photosensitive layer 29A is charged in the same way as in the second embodiment. In this case, the charger 22A charges the photosensitive layer 29A during monochrome printing to a second surface potential (potential in the range from 300 [V] to 400 [V]) that is lower than the first surface potential and that suppresses changes in the wear amount of the photosensitive layer 29A during monochrome printing and during color printing.

In a case where the photosensitive layer 29A has a third film thickness (less than 30 [μm]) that is thinner than the second film thickness, the photosensitive layer 29A is charged in the same way as in the first embodiment. In this case, the charger 22A charges the photosensitive layer 29A during monochrome printing to a third surface potential (potential in the range from 10 [V] to 150 [V]) that is lower than the second surface potential and that suppresses toner adhesion and carrier adhesion to the OPC drum 21A. In a case where the photosensitive layer 29A is charged to the third surface potential during monochrome printing, the calculating portion 42 calculates the wear amount of the photosensitive layer 29A during monochrome printing to be smaller than that during color printing, and thus the film thickness of the photosensitive layer 29A can be obtained with high accuracy.

As described above, according to the third embodiment, the photosensitive layer 29A of the OPC drum 21A is charged during monochrome printing, and deterioration of performance of the photosensitive layer 29A due to deterioration of electrical characteristics is suppressed. In addition, by applying the development voltage Vdc to the developer 23A to adjust the potential difference between the photosensitive layer 29A and the developer 23A, consumption of developing agent such as toner and carrier can be suppressed. By changing the charging voltage according to the film thickness of the photosensitive layer 29A, a target surface potential can be obtained by applying the charging voltage. Depending on the surface potential of the photosensitive layer 29A, the wear amount of the photosensitive layer 29A can be calculated using a simple calculation method, and there is no need to add a dedicated sensor, contact/separation function, or the like to the printer 1. By applying a voltage corresponding to the film thickness of the photosensitive layer 29A, color fogging during color printing can be suppressed and image quality can be improved.

Note that in the first and third embodiments, the calculating portion changes the correction coefficient to calculate the wear amount of the photosensitive layer of the OPC drum during monochrome printing to be smaller than that during color printing; however, a method of calculating the wear amount is not particularly limited.

In addition, in the present embodiment, the type of recording media is not particularly limited, and may be, for example, plain paper, coated paper, tracing paper, or an OHP (Over Head Projector) sheet.

Further, in the present embodiment, a printer is exemplified as an image forming apparatus; however, configuration is not limited to this. The image forming apparatus, in addition to being a copier or a facsimile machine, may be a multifunction peripheral having a printing function, a copy function, a facsimile function, and the like.

Note that, although the present embodiment has been described, other embodiments may be wholly or partially combined with the above embodiments and modifications.

In addition, the technology of the present disclosure is not limited to the above embodiments, and may be changed, replaced, and modified in various ways without departing from the spirit of the technical idea. Furthermore, in a case where a technical idea can be realized in another way due to advances in technology or another derived technology, the method may be used for implementation. Therefore, the claims cover all implementations that may fall within the scope of the technical concept.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus with a monochrome OPC drum and a color OPC drum, comprising:
a charger configured to charge a surface of a photosensitive layer of the color OPC drum;
a developer configured to perform development using a developing agent including a toner and a carrier; and
a calculating portion configured to calculate a wear amount of the photosensitive layer of the color OPC drum; wherein
the charger charges the photosensitive layer of the color OPC drum during monochrome printing to a surface potential that suppresses adhesion of toner and carrier to the color OPC drum; and
the calculating portion calculates the wear amount of the photosensitive layer of the color OPC drum during monochrome printing to be less than during color printing.

2. The image forming apparatus according to claim 1, wherein
the charger charges the photosensitive layer of the color OPC drum during monochrome printing within a range from 10 [V] to 150 [V].

3. An image forming apparatus with a monochrome OPC drum and a color OPC drum, comprising:
a charger configured to charge a surface of a photosensitive layer of the color OPC drum;
a developer configured to perform development using a developing agent including a toner and a carrier; and
a calculating portion configured to calculate a wear amount of the photosensitive layer of the color OPC drum; wherein
the charger charges the photosensitive layer of the color OPC drum during monochrome printing to a surface potential that is lower than a surface potential during color printing, and that suppresses a change in the wear amount of the photosensitive layer of the color OPC drum during monochrome printing and during color printing.

4. The image forming apparatus according to claim 3, wherein
the charger charges the photosensitive layer of the color OPC drum during monochrome printing within a range from 300 [V] to 400 [V].

5. An image forming apparatus with a monochrome OPC drum and a color OPC drum, comprising:
a charger configured to charge a surface of a photosensitive layer of the color OPC drum;
a developer configured to perform development using a developing agent including a toner and a carrier; and
a calculating portion configured to calculate a wear amount of the photosensitive layer of the color OPC drum; wherein
the charger charges the photosensitive layer of the color OPC drum during monochrome printing so that a surface potential of the photosensitive layer of the color OPC drum decreases as a film thickness of the photosensitive layer of the color OPC drum decreases.

6. The image forming apparatus according to claim 5, wherein
when the photosensitive layer of the color OPC drum has a first film thickness, the charger charges the photosensitive layer of the color OPC drum during monochrome printing to a first surface potential that is the same as during color printing;
when the photosensitive layer of the color OPC drum has a second film thickness that is thinner than the first film thickness, the charger charges the photosensitive layer of the color OPC drum during monochrome printing to a second surface potential that is lower than the first surface potential, and that suppresses a change in the wear amount of the photosensitive layer of the color OPC drum during monochrome printing and during color printing;
when the photosensitive layer of the color OPC drum has a third film thickness that is thinner than the second film thickness, the charger charges the photosensitive layer of the color OPC drum during monochrome printing to a third surface potential that is lower than the second surface potential and that suppresses toner adhesion and carrier adhesion to the color OPC drum; and
when the photosensitive layer of the color OPC drum during monochrome printing is charged to the third surface potential, the calculating portion calculates the wear amount of the photosensitive layer of the color OPC drum during monochrome printing to be less than during color printing.
